(19) United States
(12) Patent Application Publication
(10) Pub. No.: US 2019/0225390 A1
(43) Pub. Date: Jul. 25, 2019

(54) CONTAINER

(71) Applicant: KOCHER-PLASTIK MASCHINENBAU GMBH, Sulzbach-Laufen (DE)

(72) Inventors: Michael SPALLEK, Ingelheim (DE); Johannes GESER, Gerlingen (DE); Philipp SPRENG, Neu-Ulm (DE)

(21) Appl. No.: 16/338,516

(22) PCT Filed: Dec. 13, 2017
(86) PCT No.: PCT/EP2017/001425

§ 371 Date: Apr. 1, 2019

(30) Foreign Application Priority Data
Jan. 5, 2017 (DE) 10 2017 000 048.4

(51) Int. Cl. B65D 51/00; A61J 1/14

(52) U.S. Cl. CPC B65D 51/002; A61J 1/1406

(57) ABSTRACT

A container, consisting of an at least partially filled container body, and of at least one cap part (10), which has at least one sealing part (16) which, for removal of the container contents, can be penetrated by a hollow-spike-like insertion part (22) from the outside, with a predeterminable actuating force, in an introduction direction, it being possible for said insertion part to be removed from the container again, with a predeterminable pull-out force, in an oppositely directed pull-out direction, is characterized by the presence of a device (16, 18) which makes it difficult for the insertion part (22) to be removed and by means of which the pull-out force is increased such that unintentional removal of the insertion part (22) is at least made difficult.

The invention concerns a container that is at least partially filled and closed, manufactured in particular according to a blow-molding, filling and sealing process, consisting of a container body that is at least partially filled, the end of which is at least partially closed through a head diaphragm and which comprises a cap part with a sealing part which, for removal of the container contents, may be penetrated with a hollow, spike-like insertion part (“spike”) from the outside in an insertion direction with a predeterminable actuating force, and which may be removed again with a predeterminable retraction force in an opposite retraction direction.

Containers that are made from plastic according to the Blow-Fill-Seal (BFS) method, which is also known as Bottelpack® method, are widely used for medical purposes, for example in form of infusion bottles. Such containers are particularly suitable for medical applications because the filling material comes only into contact with a polymer. Containers of this kind are prior art. The document U.S. Pat. No. 5,395,365, for example, describes a container of this kind. To ensure that the usability of such containers in medical operations is simple and safe, the sealing part must provide a secure seal during and after insertion with the insertion part of an infusion device, which is described by way of example in EN 8536-4.

Two further requirements, which are contradictory in principle, must be met simultaneously, that is, that the insertion force is kept as low as possible but the retraction of the insertion part is only possible against suitably high retraction forces.

High retaining forces or good grip must be ensured to provide the patient with a certain level of mobility during the often lengthy process of infusion administration so that the patient is able to move freely without interrupting the infusion by unintentionally pulling out the infusion device. According to the standard ISO 15759:2006, the retaining force of the infusion device, therefore, must not be less than 15 N. This standard, on the other hand, permits insertion forces of up to 80 N.

The attempt to provide a sufficiently high retaining force by accepting a high insertion force is not practical because high insertion forces cannot be achieved by the nursing staff, especially when wearing gloves. These contradictory requirements, that is, easy to insert but difficult to retract, can also not be met by other simple measures such as arrow-like insertion parts with undercuts or barbs since this could lead to leakage of the sealing part, and also such a geometrical shape of the insertion part violates the applicable standard EN ISO 8536-4:2013.

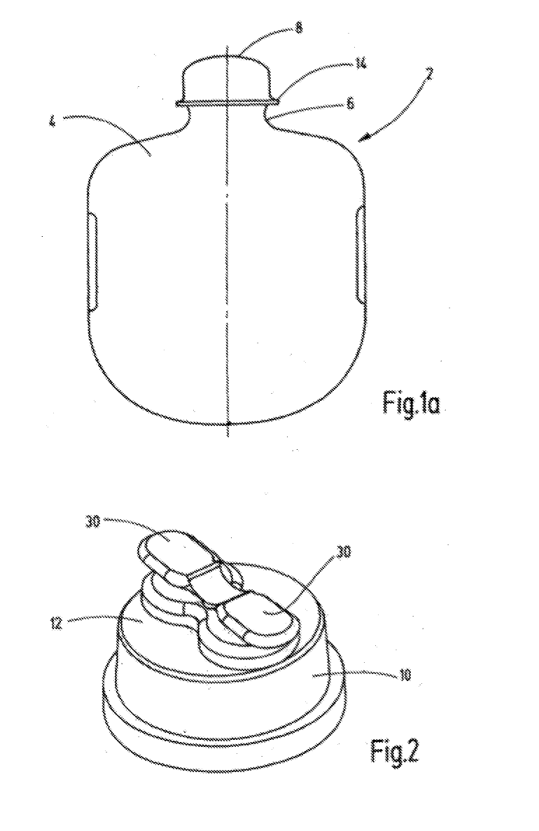

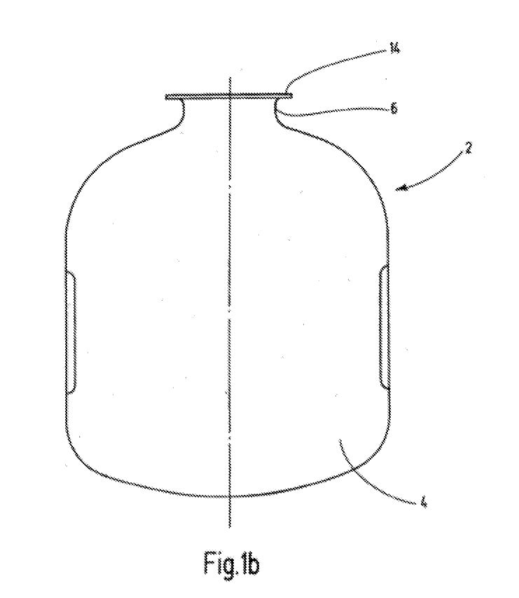

Known sealing caps, such as are described in DE 10 2004 051 300 B3, EP 1 457 429 B1 and WO 2014/114685 A1 for example, do not meet the above-described, in principle contradictory, requirements. These documents propose to use a hollow stopper to make the tapping easier. DE 10 2004 051 300 B3 depicts recesses in the elastomer for the insertion spike that are oriented to the outside on one side. EP 1 457 429 B1 and WO 2014/114685 A1 describe that recesses for the insertion spike are provided in the elastomer on one side, oriented towards the container side. There is no apparent mechanism that would increase the retaining force. As FIG. 2 of WO 2014/114685 A1 shows, the retraction of the insertion spike is made rather easier than more difficult through a special funnel-shaped gradation.

With regard to the above problem it is the object of the invention to provide a container of the kind described at the outset, which meets the requirements for the application of the container in a special way.

Said object is met according to the invention by a container of the kind described at the outset, which bears the characteristics of claim 1 in its entirety.

Accordingly, the invention is characterized in that a device is provided that makes the removal of the insertion part more difficult, wherein the retraction force is increased to such an extent that an inadvertent removal of the insertion part is at least made more difficult, but the insertion force is not increased by this device.

In particularly advantageous exemplary embodiments a sealing part, which is a component of the device that makes the removal of the insertion part more difficult, is provided in a cap part of the container body in such a way that, when the sealing part, which is a component of the device, is penetrated, a radial distance is provided between a through-hole in the cap part and the insertion part that was introduced, and that, at least when said insertion part is removed from the container in retraction direction, the radial distance is at least partially packed by the sealing part, which is a further component of the device, which applies at least an increased frictional force on the insertion part, at least in certain sections, during its retraction from the container. Through the displacement of the sealing part material caused by the retraction movement and the filling of the radial distance, a friction and compression zone is formed at the through-hole in the cap part, which impedes the retraction movement.

The through-hole in the cap part may, in conjunction with the outer circumference of the introduced insertion part, advantageously delimit an annular duct which, when retrieving the insertion part from the container, is completely packed to the surroundings by this further part of the device under formation of a bead-like projection which, being jammed in the annular duct, applies an additional clamping force onto the insertion part.

In a particularly advantageous manner the sealing part consists of a preferably soft, elastomeric material. The sealing part extends between the cap part and a head diaphragm of a head part of the container and is preferably provided with a recess at the end that is facing away from head diaphragm of the head part.

In advantageous exemplary embodiments the sealing part is provided, at its end that faces the head diaphragm of the head part of the container, with a further sealing ring-shaped geometry that is an axially protruding extension of its recess in the direction of the head diaphragm, which can brace itself, at least during the inserting of the insertion part, in a sealing manner against the upper end of the head diaphragm of the container facing it. This forms a further seal at the head diaphragm that surrounds the perforation.

The through-hole of the cap part may be covered with respect to the surroundings by a removable strap, a foil or similar so as to provide a secure cover over the sealing part when the container is stored prior to its use. The following describes mostly embodiments with a strap. However, they may be implemented equally well with a foil.

The cap part, which is preferably made form a rigid plastic material, may be attached to a collar of the container below its head part.

The cap part may advantageously be provided with a further, separate sealing part, for example a sealing part for cannula passage. Said second sealing part may be made from a different material than the first one and/or may have a different geometric shape and thus may be easily adapted to the application. The container is therefore suitable for multiple applications, for example the possibility of introducing an additive by piercing the further sealing element, for example by means of an injection cannula.

According to claims 14 to 21, subject of the invention is also a cap part, which is provided for a container according to one of the claims 1 to 13.

The invention will now be described in greater detail by way of an exemplary embodiment shown in the drawing.

Shown are in:

FIG. 1a, b depicted at approximately half the size, a front view each of two known infusion containers;

FIG. 2 a perspective view, slightly enlarged, of a separately shown cap part of an exemplary embodiment;

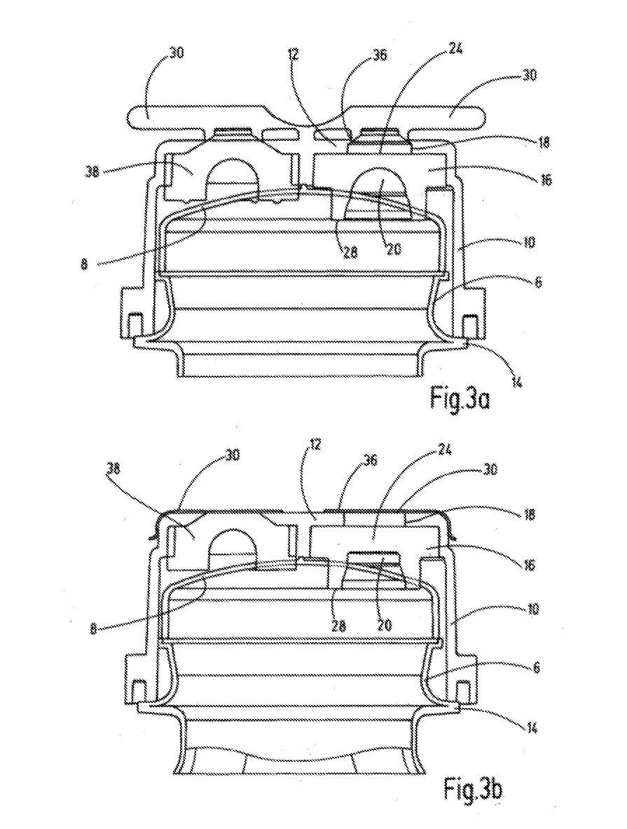

FIG. 3a, b a cross-section each, depicted slightly enlarged, of the head part of the container of FIG. 1a, shown with attached cap part, wherein a flexible head diaphragm of the head part is shown in a non-deformed position prior to the attachment of the cap part, and wherein the head part

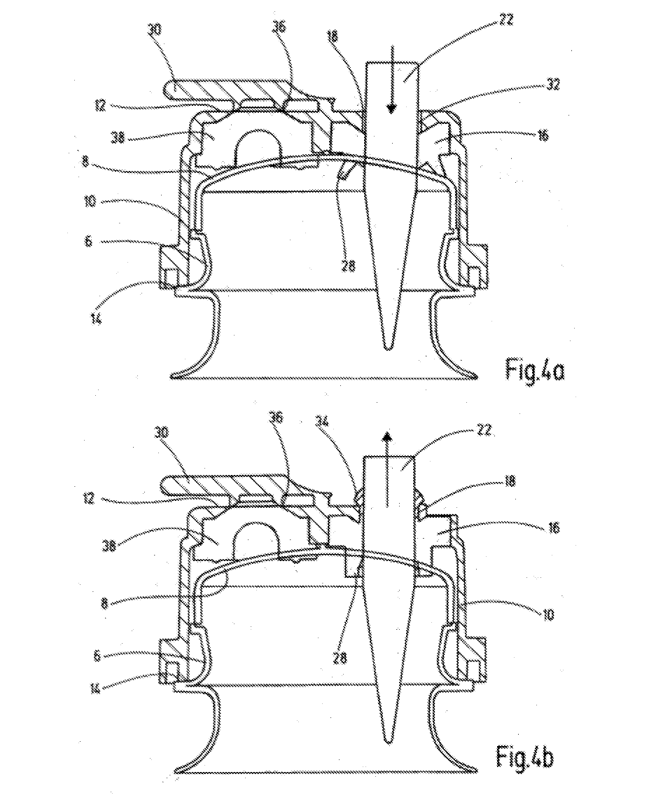

FIG. 4a a cross-section corresponding to FIG. 3a, which depicts the state during the insertion movement of an insertion part for carrying out a removal action of the container contents;

FIG. 4b a depiction corresponding to FIG. 4a, which shows the state during the retraction movement of the insertion part;

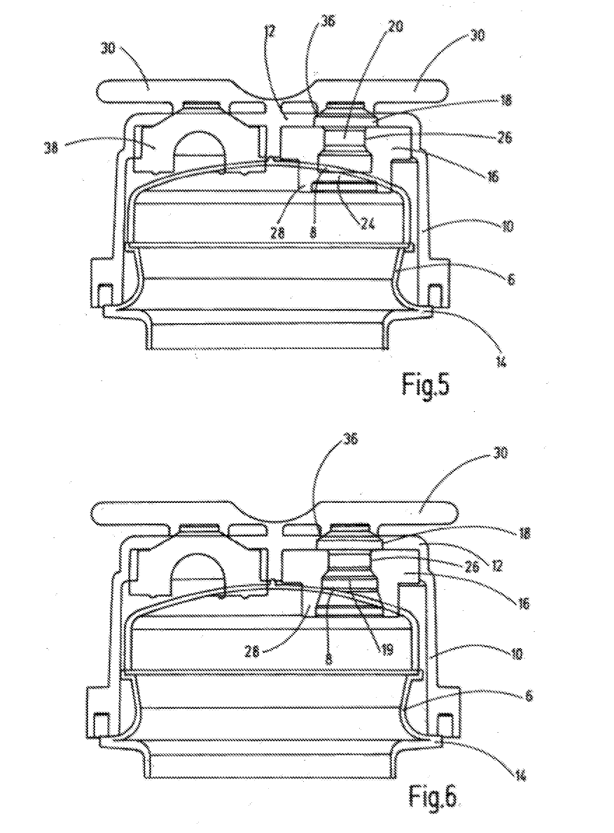

FIG. 5 in cross-section a depiction of a further embodiment with a sealing element and a changed diaphragm position;

FIG. 6 in cross-section a depiction of a further embodiment with a sealing element without a diaphragm;

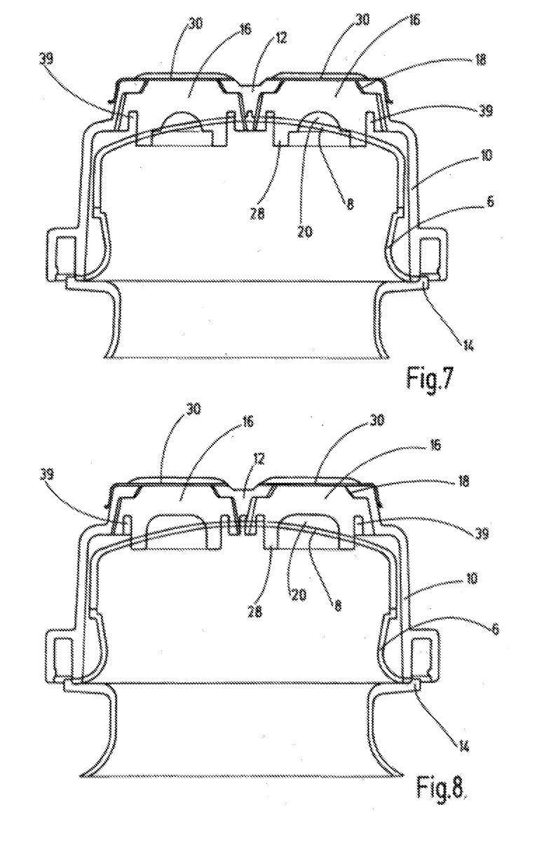

FIG. 7 in cross-section a depiction of a further embodiment with special annular groove geometry of both sealing elements and a strap made from foil material;

FIG. 8 in cross-section a depiction of a further embodiment, changed compared with the solution according to FIG. 7, with special annular groove geometry of both sealing elements and a strap made from foil material; and

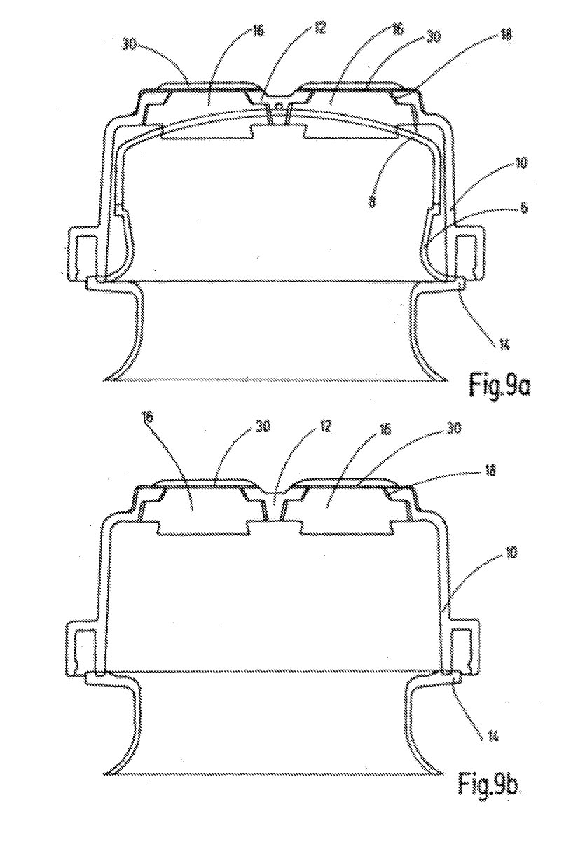

FIG. 9a, b depictions in cross-section of a further embodiment with two sealing elements with a stopper-like geometry, affixed to a container according to FIG. 1a and FIG. 1b respectively.

The FIGS. 1a and 1b depict two exemplary embodiments of the plastic container 2 according to the invention, each in form of an infusion container known per se, comprising a bag-like container body 4 and a rim part 14. In the example according to FIG. 1a the head part 6 is comprised of a flexible head diaphragm 8 that is formed in one piece with the remaining container wall, wherein said head diaphragm 8 forms a removal zone for the removal of the contents of the container. Containers of this kind may be manufactured using the known blow-fill-seal technology (BFS technology). In the example according to FIG. 1b the head part 6 and thus the container 4 is open. Such containers are manufactured using the blow-molding technology known per se, preferably the stretch blow-molding technology or the injection stretch blow-molding technology.

The FIGS. 2 and 3a, b each depict a cap part 10, preferably made from a rigid plastic material, which has largely the shape of a circular cup with bottom 12 and detachable straps 30. In FIGS. 3a, b said cap part 10 is attached by way of substance bonding to a radially protruding rim part 14 at the head part 6 of the container 2 according to FIG. 1a. Disposed between the inner side of the bottom 12 of the cap part 10 and the head diaphragm 8 is at least a sealing part 16, which provides for the secure removal of the contents of the container 2, wherein said sealing part 16 may be pierced by an insertion part 22 for a removal action, and which forms part of the device that makes the removal of the insertion part 22 from container 2 more difficult and at the same time acts as a seal at the insertion part 22. To this end the sealing part 16 is made from an elastomeric material with very little rigidity and hardness. In particular materials such as halogen butyl rubber, synthetic rubber, for example polyisoprene, thermoplastic elastomers, silicon, natural rubber, nitrile rubber, are well suited. Preferred are thermoplastic elastomers, which may be substance-bonded through welding to the cap part 10. Each of the FIGS. 3a and 3b shows the geometry of the sealing part 16, which is disposed at the bottom 12 of the cap part 10, oriented towards a through-hole 18 of the cap part 10. The through-hole 18 at the bottom 12 of the cap part 10 is covered towards the surroundings by a strap 30, which in the example of FIG. 3a is made of a solid material and in the example of FIG. 3b of a foil. Said strap 30 is removable from the upper edge 36 of the through-hole 18 to open up said through-hole 18 prior to a removal action. It is of great advantage in both instances if the upper diameter of the through-hole 18 is as small as possible so that it is easy for the user to remove the strap 30.

On the side of the strap 30 the sealing part 16 is provided with a continuous piercing diaphragm 24, which is penetrated during the removal action. At the side of the head diaphragm 8 the sealing part 16 is provided with a central recess 20, which is flush with the through-hole 18 and which is provided for an insertion part 22 of an infusion device (FIGS. 4a and 4b). The axially protruding sealing ring geometry 28 of the sealing part 16 seals the removal zone at the head diaphragm 8 of the container head part 6.

The geometry, and in particular the diameter, of the through-hole 18 compared to the diameter of the insertion part 22 is chosen such that (see FIG. 4a) an annular duct 32 is formed between the outer circumference of the insertion part 22 and the though-hole 18 as said insertion part 22 penetrates. As shown in FIG. 4b, which depicts the state shortly after commencement of pulling the insertion part 22 out, said annular duct 32 is fully packed through the elastically deformed, displaced material of the sealing part 16, which results from the retraction movement. This causes an additional friction force between the insertion part 22 and the bottom 12 of the cap part 10, and wherein the displaced material forms a bead-like projection 34 on the outside of the bottom 12 as a further impeding friction zone.

FIG. 5 depicts a special embodiment in which the sealing part 16 is provided with a recess 20 and a sealing bead-like geometry 26 disposed directly at the through-hole 18, wherein the free internal diameter of said geometry 20 is substantially smaller than the diameter of the through-hole 18. This causes the material of the sealing part 16, 26, which is moved during the retraction movement, to be pulled into the annular duct 32 (see FIG. 4b), which causes an additional friction force that impedes the further retracting of the insertion part 22. A further sealing ring geometry 28 extends from circumferential edge of the diaphragm 24 in the direction of the head diaphragm 8 of the container head part 6.

FIG. 6 depicts a further special embodiment, similar to that of FIG. 5, in which the sealing part 16 is not provided with a diaphragm but with a passage 19. This provides for minimal piercing forces but at the same time offers high retraction resistance through the sealing bead-like geometry 26 of the sealing part 16 close to the through-hole 18 in cap part 10.

FIG. 7 depicts a further special embodiment, similar to that of FIG. 3b, with two separate sealing parts 16 of the same kind. The trough-hole 18 in cap part 10 has a conical shape, which makes the attachment of the respective sealing part 16 or sealing element to the cap part 10 easier. Because the through-hole 18 is almost completely packed by the sealing part 16, the annular duct 32 is not as deep compared to the embodiment according to FIG. 4a, nevertheless, it was surprising to see that, when retracting the insertion part 22, the annular duct 32 was packed with a bead-like projection 34 similar to FIG. 4b and a retraction resistance according to the invention. A circumferential annular groove 39 inside the sealing element 16 has a reducing effect on the piercing forces because a lateral, elastic movement or displacement of the sealing part 16 by the insertion part 22 is possible.

FIG. 8 depicts a further special embodiment, similar to that of FIG. 7, also with a conical geometry of the through-hole 18 with two separate sealing parts 16 of the same kind but, compared to the example in FIG. 7, with narrower sealing ring geometry 28.

FIGS. 9a and 9b respectively depict a further special embodiment, similar to that of FIG. 7, with two separate sealing parts 16 of the same kind and with a geometry that is particularly easy to manufacture, attached to a container according to FIG. 1a (with head diaphragm 8) and FIG. 1b (without head diaphragm) respectively.

It came as a surprise to realize that an easy removal of the strap 30, a small piercing force and an advantageous increase of the retraction force of the insertion part 22 is only achieved through the synergistic interaction of the following multiple factors:
1—Material characteristics of the sealing part 16, in particular Shore hardness;
2—Geometric design of the through-hole 18, 36;
3—Attachment of sealing part 16 at the bottom 12 of cap part 10;
4—Positioning of the diaphragm 24 of the sealing part 16 and its sealing bead-like geometry 26 respectively relative to the through-hole 18.

This may be achieved, according to the invention, if
a) the material for the sealing part 16 has a Shore hardness according to ISO 868 of 10 to 60 Shore A, preferably of 20 to 50 Shore A, particularly preferred from 30 to 40 Shore A, as well as
b) the diameter of the through-hole 18 is at least 6 mm and at most 8 mm, preferably at least 6.2 mm and at most 7.0 mm, particularly preferred at least 6.2 mm and at most 6.8 mm, as well as
c) the elastomeric sealing part 16 fills the through-hole 18 of the cap part 10 or at least is in direct contact with its edge and is attached to the bottom 12 preferably through substance bonding, for example through welding or adhesive bonding, and/or
d) in the instance of the embodiment according to FIG. 5 or FIG. 6 the difference D of the diameter of the through-hole 18 and of the free internal diameter at the geometry 26 of the sealing part 16 is greater than 1.5 mm, preferably greater than 2 mm, particularly preferred greater than 2.5 mm.

The reduction of the actuating force during insertion of the insertion part 22 is achieved through a particular embodiment of the sealing part 16, the diaphragm 24 of which is made either very thin or, for example, is weakened through slots or perforations.

As depicted, for example, in FIG. 3a and in FIG. 3b, it is possible to provide in the cap housing, besides the sealing part 16, a second elastomeric, stopper-like sealing part 38 at a further through-hole in cap part 10, which is also covered by the strap 30. Said sealing part 38, which also has an axially protruding, sealing ring-like geometry for making contact with the head diaphragm 8 of the container head part 6, may be pierced for admixture of an additive to the container contents or for removal of the content by means of an injection cannula.

### EXEMPLARY EMBODIMENTS

The following examples (tests No. 1-No. 43) provide further explanations to the invention. Into cap parts 10 according to FIG. 6, made from polypropylene Purell RP 270G by LyondellBasell, with different diameters of the through-hole 18, elastomeric sealing elements 16 with different free internal diameters of the sealing bead-like geometry 26 made from different elastomers and different Shore hardness were inserted and attached to the bottom 12 of the cap part 10. When using polyisoprene as sealing element 16 the sealing elements were adhesively bonded, when using thermoplastic elastomers (TPE) the sealing elements were laser-welded after being pressed into the cap part 10.

To be able to measure piercing forces independent from the head diaphragm 8 of the container, the cap parts were not welded to the container but were tested without them.

The maximum penetration forces (insertion forces) and dynamic retaining forces (retraction forces) were determined, similar to the description in DIN ISO 15759, with a universal testing machine Class 1 according to ISO 7500-1 with unused, commercially available insertion parts similar to ISO 8536-4 from different manufacturers as well as with the reference mandrel according to DIN ISO 15759 Appendix I. They have three different external diameters (5.4 mm, 5.6 mm and 6.0 mm). The test speed was 200 mm per minute according to the standard EN ISO 15747:2012.

The results, which are average values from 5 to 10 measurements, are compiled in the following table. The fourth column (column D) of this table is calculated from the diameter at the through-hole 18 at the strap end, less the free internal diameter at the geometry 26 of sealing part 16.

| | | External | | | | | |
|---|---|---|---|---|---|---|---|
| | Diameter | diameter of | | Hardness | | | |
| | opening in | insertion | | of sealing | Insertion | Retraction | |
| | cap part | part | D | part | force E | force A | Ratio of |
| Test No. | In mm | In mm | In mm | Shore A | In N | In N | forces A:E |
| 1 | 6.8 | 6.0 | 1 | 30 | 12.3 | 8.0 | 0.65 |
| 2 | 6.6 | 5.6 | 2.6 | 60 | 48.6 | 31.9 | 0.66 |
| 3 | 7.0 | 5.6 | 3 | 60 | 50.3 | 33.7 | 0.67 |
| 4 | 6.0 | 5.6 | 2 | 60 | 46.1 | 31.9 | 0.69 |
| 5 | 7.0 | 5.6 | 3 | 40 | 35.4 | 24.8 | 0.70 |
| 6 | 8.0 | 6.0 | 2.5 | 30 | 27.4 | 19.3 | 0.70 |
| 7 | 6.2 | 5.6 | 2.2 | 60 | 45.7 | 32.7 | 0.72 |
| 8 | 6.8 | 5.6 | 2.8 | 50 | 32.9 | 24.9 | 0.76 |
| 9 | 6.8 | 5.6 | 2.8 | 60 | 49.4 | 38.0 | 0.77 |
| 10 | 6.8 | 6.0 | 1 | 40 | 15.4 | 12.0 | 0.78 |
| 11 | 6.0 | 6.0 | 2 | 30 | 30.9 | 25.1 | 0.81 |
| 12 | 6.8 | 6.0 | 1 | 50 | 17.0 | 14.0 | 0.82 |
| 13 | 6.2 | 5.6 | 2.2 | 50 | 33.4 | 27.6 | 0.83 |
| 14 | 6.8 | 5.6 | 1.5 | 30 | 15.1 | 12.5 | 0.83 |
| 15 | 6.4 | 5.6 | 2.4 | 60 | 42.9 | 35.6 | 0.83 |
| 16 | 6.6 | 5.6 | 2.6 | 50 | 31.8 | 27.1 | 0.85 |
| 17 | 6.8 | 5.4 | 4 | 50 | 49.9 | 42.6 | 0.85 |
| 18 | 7.0 | 6.0 | 2.5 | 30 | 29.0 | 25.5 | 0.88 |
| 19 | 6.8 | 6.0 | 1 | 60 | 20.5 | 18.6 | 0.91 |
| 20 | 8.0 | 5.6 | 4 | 50 | 35.2 | 33.7 | 0.96 |
| 21 | 6.4 | 5.6 | 2.4 | 50 | 36.3 | 35.6 | 0.98 |
| 22 | 6.8 | 5.4 | 4 | 60 | 48.6 | 47.9 | 0.99 |
| 23 | 6.0 | 5.6 | 2 | 50 | 32.8 | 32.7 | 1.00 |
| 24 | 6.8 | 5.4 | 2.5 | 50 | 32.0 | 35.9 | 1.12 |
| 25 | 6.8 | 5.4 | 2.5 | 60 | 35.5 | 42.3 | 1.19 |
| 26 | 6.0 | 5.6 | 2 | 30 | 27.6 | 32.9 | 1.19 |
| 27 | 7.0 | 5.6 | 3 | 30 | 25.4 | 33.7 | 1.33 |
| 28 | 6.6 | 5.6 | 2.6 | 30 | 24.0 | 31.9 | 1.33 |
| 29 | 6.2 | 6.0 | 2.2 | 30 | 31.8 | 43.3 | 1.36 |
| 30 | 6.8 | 5.4 | 4 | 30 | 40.0 | 56.7 | 1.42 |
| 31 | 6.8 | 5.4 | 2 | 30 | 18.5 | 27.6 | 1.49 |
| 32 | 6.4 | 6.0 | 2.4 | 40 | 29.4 | 44.2 | 1.50 |
| 33 | 6.8 | 5.4 | 2.8 | 30 | 25.1 | 39.7 | 1.58 |
| 34 | 6.8 | 5.6 | 2.8 | 30 | 23.0 | 38.0 | 1.65 |
| 35 | 6.4 | 5.6 | 2.4 | 30 | 27.4 | 47.0 | 1.72 |
| 36 | 6.8 | 5.4 | 3.5 | 30 | 31.2 | 54.2 | 1.74 |
| 37 | 6.8 | 6.0 | 2.8 | 30 | 28.7 | 50.9 | 1.77 |
| 38 | 6.6 | 5.4 | 2.6 | 30 | 29.0 | 52.7 | 1.82 |
| 39 | 6.8 | 5.4 | 4 | 40 | 28.3 | 52.0 | 1.84 |
| 40 | 6.2 | 5.6 | 2.2 | 30 | 25.1 | 46.2 | 1.84 |
| 41 | 6.6 | 6.0 | 2.6 | 30 | 26.3 | 48.7 | 1.85 |
| 42 | 6.8 | 5.4 | 2.5 | 40 | 25.0 | 48.7 | 1.95 |
| 43 | 6.8 | 5.4 | 2.8 | 30 | 23.4 | 52.2 | 2.23 |

Very advantageous ratios between retraction force A and insertion force E result, according to the invention, where the material for the sealing part has a hardness of between 30 and 40 Shore A, where the diameter of the through-hole in the cap part is between 6.2 mm and 6.8 mm, and where the difference D is at least 2.5 mm.

1. A container, comprised of an at least partially filled container body (4), and at least one cap part (10), which is provided with at least one sealing part (16), which may be penetrated from the outside in an insertion direction with a predeterminable actuating force by a hollow spike-like insertion part (22) for removal of the container contents, which may be removed again from the container (2) with a predeterminable retraction force in an opposite retraction direction, characterized in that a device (16, 18, 26, 32) is provided that makes the removal of the insertion part (22) more difficult, by means of which its retraction force is increased to such an extent that an unintended removal of the insertion part (22) is at least made more difficult.

2. The container according to claim 1, characterized in that it is manufactured by way of a blow-fill-seal technology, and that it is closed at the end by at least one pierceable head diaphragm (8).

3. The container according to claim 1, characterized in that the sealing part (16) is housed in the cap part (10) in such a way that, when the sealing part (16), which is a component of the device (16, 18, 26, 32), is penetrated, a radial distance is provided between a through-hole (18) in the cap part (10) and the insertion part (22) that was introduced, and that, at least when said insertion part (22) is removed from the container (2) in retraction direction, the annular duct (32) is at least partially packed by the sealing part (16) of the device, which applies an increased frictional force on the insertion part (22), at least in certain sections, during its retraction from the container (2).

4. The container according to claim 1, characterized in that the through-hole (18) in the cap part (10) forms, in conjunction with the outer circumference of the introduced insertion part (22), an annular duct (32) with predeterminable axial length which, when retrieving the insertion part (22) from the container (2), said annular duct (32) is completely packed to the surroundings by a further part (26) of the device (16, 18, 26, 32) under formation of a bead-like projection (34) which, being jammed in the annular duct (32), applies an additional clamping force onto the insertion part (22).

5. The container according to claim 1, characterized in that the sealing part (16) consists of a preferably elastomeric material, which extends between the cap part (10) and a head part (6) of the container (2) and is provided with a recess (20) that is disposed coaxial to the through-hole (18) in cap part (10), wherein said recess (20) follows in axial extension after the through-hole (18).

6. The container according to claim 1, characterized in that the sealing part (16) consists of a preferably elastomeric material, which extends between the cap part (10) and a head diaphragm (8) of a head part (6) of the container (2) and is provided with a passage (19) that is disposed coaxial to the through-hole (18) in cap part (10), wherein said passage (19) follows in axial extension after the through-hole (18).

7. The container according to claim 1, characterized in that the sealing part (16) has an annular, bead-like part geometry (26), which protrudes radially to the inside into the recess (20) or the passage (19) which, under the action of the retracting insertion part (22), is displaced in the direction of the annular duct (32) of the through-hole (18) and jams.

8. The container according to claim 1, characterized in that the recess (20) of the sealing part (16, 26) is closed by a piercing diaphragm (24), which may be pierced by the insertion part (22).

9. The container according to claim 1, characterized in that, at the end that faces the head diaphragm (8) of the head part (6) of the container (2), the sealing part (16, 26) is provided with an extension of its recess (20), or a further part geometry (28) that protrudes axially from passage (19) in the direction of the head diaphragm (8), where said part geometry (28) is braced, at least during insertion of the insertion part (22), in a sealing manner against the facing upper side of the head diaphragm (8) of container (2).

10. The container according to claim 1, characterized in that the through-hole (18) of cap part (10) is covered towards the surroundings by a detachable strap (30).

11. The container according to claim 1, characterized in that the detachable strap (30) is formed by a foil.

12. The container according to claim 1, characterized in that the cap part (10) is attached to the rim part (14) of the container (2) below its head part (6).

13. The container according to claim 1, characterized in that at least a further sealing part (38) is housed inside cap part (10), such as a sealing element provided for the passage of a cannula.

14. A cap part (10) for a container according to claim 1, characterized in that it is provided with an elastomeric sealing part (16) with a recess (20), which is sealed by a piercing diaphragm (24), which separates a radially-acting annular bead-shaped part geometry (26) from an axially-acting sealing ring-shaped part geometry (28) of the sealing part (16).

15. The cap part (10) for a container according to claim 1, characterized in that the elastomeric sealing part (16) is provided with an at least partial circumferential annular groove (39).

16. The cap part (10) for a container according to claim 1, characterized in that the material for the sealing part (16) has a Shore hardness between 10 and 60 Shore A, preferably between 20 and 50 Shore A, particularly preferred between 30 and 40 Shore A.

17. The cap part (10) for a container according to claim 1, characterized in that the diameter of the through-hole (18) at the strap end is at least 6 mm and at most 8 mm, preferably at least 6.2 mm and at most 7 mm, particularly preferred at least 6.2 mm and at most 6.8 mm.

18. The cap part (10) for a container according to claim 1, characterized in that the elastomeric sealing part (16) is attached through substance bonding, for example through welding or adhesive bonding, to the bottom (12) of cap part (10) directly adjacent to the through-hole (18).

19. The cap part (10) for a container according to claim 1, characterized in that the difference D of the diameter of the through-hole (18) at the strap end and the free internal diameter at the geometry (26) of the sealing part (16) is more than 1.5 mm, preferably more than 2 mm, particularly preferred more than 2.5 mm.

20. The cap part (10) for a container according to claim 1, characterized in that the through-hole (18) is tapered towards the strap (30).

21. The cap part (10) for a container according to claim 1, characterized in that the through-hole (18) is at least partially packed by the elastomeric sealing part (16).
